(19) United States
(12) Patent Application Publication
(10) Pub. No.: US 2024/0038986 A1
(43) Pub. Date: Feb. 1, 2024

(54) POSITIVE ELECTRODE MATERIAL AND PREPARATION METHOD THEREOF, POSITIVE ELECTRODE PLATE AND BATTERY INCLUDING THE POSITIVE ELECTRODE MATERIAL

(71) Applicant: ZHUHAI COSMX POWER BATTERY CO., LTD., Zhuhai (CN)

(72) Inventors: Peng WU, Zhuhai (CN); Suli LI, Zhuhai (CN)

(73) Assignee: ZHUHAI COSMX POWER BATTERY CO., LTD., Zhuhai (CN)

(21) Appl. No.: 18/360,523

(22) Filed: Jul. 27, 2023

(30) Foreign Application Priority Data
Jul. 28, 2022 (CN) 202210903868.7

(51) Int. Cl. H01M 4/525; H01M 10/0525; H01M 4/62

(52) U.S. Cl. CPC H01M 4/525; H01M 10/0525; H01M 4/624; H01M 2004/021

(57) ABSTRACT

Disclosed are a positive electrode material and a preparation method thereof, a positive electrode plate, and a battery. The positive electrode material includes several particles having a polymeric single crystal morphology, and the particle having a polymeric single crystal morphology is formed by nesting several primary particles; and the positive electrode material meets a relational expression shown in Formula 1 as follows: D₅₀³=K×n×d₅₀³ Formula 1, where K is a coefficient having a range of 0.2≤K≤2; n is a quantity of primary particles having a range of 2≤n≤500; D₅₀ is a median particle size of a positive electrode material, in a unit of μm; and d₅₀ is a median particle size of a primary particle, in a unit of The positive electrode material can ensure good cycling performance, stable high voltage cycling performance and safety performance.

### CROSS-REFERENCE TO RELATED APPLICATIONS

The present application claims priority to Chinese Patent Application No. 202210903868.7, filed on Jul. 28, 2022, which is hereby incorporated by reference in its entirety.

### TECHNICAL FIELD

The present disclosure belongs to the field of battery technologies, and specifically, relates to a positive electrode material with a special morphologic structure and a preparation method thereof, a positive electrode plate and a battery including the positive electrode material.

### BACKGROUND

At present, positive electrode materials for a lithium-ion battery are classified into two categories: single crystal and secondary sphere. A single crystal material is widely used in a pouch lithium-ion battery due to features such as good cycling performance, high compacted density, and good resistance to high voltage. However, the single crystal material also has disadvantages of relatively low capacity per gram and poor C-rate performance. A secondary sphere material is mostly a sphere-like aggregate of primary particles, namely, secondary particles formed by agglomerating primary particles. The secondary sphere has features of high capacity per gram and good C-rate performance. However, secondary sphere agglomerated particles are easily broken during roll pressing, with a low compacted density and poor cycling performance.

Therefore, it is necessary to develop a positive electrode material having high capacity per gram, good cycling performance, and good C-rate performance.

### SUMMARY

To overcome the disadvantages in the conventional technologies, the objective of the present disclosure is to provide a polymeric single crystal positive electrode material and a battery including the positive electrode material. The positive electrode material includes several particles having a polymeric single crystal morphology, and the positive electrode material having particles with a polymeric single crystal morphology has high thermal stability, enabling the positive electrode material to have low temperature rise, high thermal stability, and high temperature cycle stability. In addition, the positive electrode material further has a characteristic of low internal resistance. The positive electrode material has characteristics of relatively high charge/discharge voltage and specific capacity, so that a battery using the positive electrode material can have relatively high capacity performance and energy density. The battery using the positive electrode material of the present disclosure can also consider both cycling performance and C-rate performance.

The objective of the present disclosure is implemented by using the technical solutions as follows.

The present disclosure provides a positive electrode material, where the positive electrode material includes several particles having a polymeric single crystal morphology, and the particle having a polymeric single crystal morphology is formed by nesting several primary particles. The positive electrode material meets a relational expression shown in Formula 1 as follows:

D₅₀³=K×n×d₅₀³ Formula 1,

where K is a coefficient having a range of 0.2≤K≤2; n is a quantity of primary particles having a range of 2≤n≤500; D₅₀ is a median particle size of a positive electrode material, in a unit of μm; and d₅₀ is a median particle size of a primary particle, in a unit of μm.

The present disclosure provides a positive electrode plate, where the positive electrode plate includes the foregoing positive electrode material.

The present disclosure provides a battery, where the battery includes the foregoing positive electrode material or the foregoing positive electrode plate.

Beneficial effects of the present disclosure are as follows.

The present disclosure provides a positive electrode material and a battery including the positive electrode material. The positive electrode material in the present disclosure has a special morphology of a polymeric single crystal. After being rolled, the positive electrode material is not broken easily, with a relatively high compacted density. A polymeric single crystal particle has a smooth surface, and is in good contact with a conductive agent, thereby facilitating transmission of lithium ions. The polymeric single crystal particle has a low initial DCR (DC resistance), and thus the positive electrode material has low temperature rise in a charge-discharge cycle process. The polymeric single crystal particle has good structural stability, so that good cycling performance and stable high voltage cycling performance can be ensured, and safety performance can be improved. Further, a surface of the positive electrode material is coated with an inert metal or a non-metal compound, which may effectively prevent damage of an electrolyte solution to the surface of the positive electrode material, thereby enhancing surface property and structural stability of the positive electrode material.

### BRIEF DESCRIPTION OF THE DRAWINGS

FIG. 1 is an SEM electron microscope diagram (polymeric single crystal) of a ternary material in Example A1.

FIG. 2 is an SEM electron microscope diagram (secondary sphere) of a ternary material in Comparative example A1.

FIG. 3 is a comparison diagram of cycle data of batteries in Example A1 and Comparative example A1.

FIG. 4 is an SEM electron microscope diagram (single crystal) of a ternary material in Comparative example A2.

FIG. 5 is a variation diagram of DC internal resistances obtained after 1200 cycles of batteries in Example A2 and Comparative Example A2.

FIG. 6 is an SEM electron microscope diagram (polymeric single crystal) of lithium cobaltate obtained after primary sintering in Example B1.

FIG. 7 is an SEM electron microscope diagram (single crystal) of lithium cobaltate obtained after primary sintering in Comparative example B1.

FIG. 8 is a diagram of an SEM electron microscope (secondary sphere) of lithium cobaltate obtained after primary sintering in Comparative example B2.

### DETAILED DESCRIPTION OF THE EMBODIMENTS

Positive Electrode Material

As described above, the present disclosure provides a positive electrode material, where the positive electrode material includes several particles having a polymeric single crystal morphology, and the particle having a polymeric single crystal morphology is formed by nesting several primary particles. The positive electrode material meets a relational expression shown in Formula 1 as follows:

D₅₀³=K×n×d₅₀³ Formula 1,

where K is a coefficient having a range of 0.2≤K≤2; n is a quantity of primary particles having a range of 2≤n≤500; D₅₀ is a median particle size of a positive electrode material, in a unit of μm; and d₅₀ is a median particle size of a primary particle, in a unit of μm.

In a conventional technology, a generally used positive electrode material mainly includes a single crystal material and a secondary sphere material. The secondary sphere material has relatively good C-rate performance, but relatively low cycling performance; and the single crystal material has relatively good cycling performance, but relatively poor C-rate performance. A reason that the secondary sphere material has relatively poor cycling performance is probably as follows: In a charge-discharge process of a battery, crystal volume expands and contracts repeatedly, and expansion and contraction directions of primary particles in a secondary sphere material are different or even opposite, thus causing a stress between the primary particles in the secondary sphere material. In addition, in a later period of cycling of the battery, interfaces of the primary particles may be pulverized, and some primary particles are deactivated, resulting in relatively fast capacity fading of the battery and poor cycling performance. Compared with the secondary sphere material, a stress in the single crystal material is relatively less, and therefore cycling performance of the single crystal material is better than that of the secondary sphere material. However, because a path of lithium ion migration is too long, C-rate performance of the single crystal material is poor. In addition, in the conventional technology, the positive electrode material is generally crystallized into a single crystal morphology of primary particles. In this way, the positive electrode material is not easily cracked after rolling, and has a relatively large compacted density. However, particles of the single crystal material are in a single crystal morphology, and contact between an electrolyte solution and interfaces of the single crystal material is insufficient. Thus, in a charge-discharge cycle process of the battery, polarization of the battery may be increased, an initial DC internal resistance DCR is relatively large, and temperature rise of the single crystal material varies greatly at different C-rates, causing some safety risks to the battery. In view of this, the inventors of the present disclosure obtain the technical solutions of the present disclosure through research.

According to an implementation of the present disclosure, K is 0.2, 0.3, 0.4, 0.5, 0.6, 0.7, 0.9, 1.0, 1.1, 1.2, 1.3, 1.4, 1.5, 1.6, 1.7, 1.8, 1.9 or 2.0.

According to an implementation of the present disclosure, n is 2, 5, 10, 20, 50, 80, 90, 100, 120, 130, 150, 180, 200, 220, 230, 240, 250, 260, 280, 300, 320, 340, 350, 380, 400, 420, 430, 450, 480, 490 or 500. In the present disclosure, n may be obtained through testing by using a conventional method in the art, for example, by using an SEM+FIB technology (a technology combining scanning electron microscope and focused ion beam).

In the present disclosure, a median particle size D₅₀ of the positive electrode material and a median particle size d₅₀ of the primary particle may be obtained by using a conventional method in the art, for example, the median particle diameter D₅₀ of the positive electrode material may be obtained by a laser particle size analyzer or scanning electron microscope (SEM) image recognition; the median particle diameter d₅₀ of the primary particle may be measured by SEM image recognition after cutting is performed by using a focused ion beam technology; or may be directly measured by SEM image recognition.

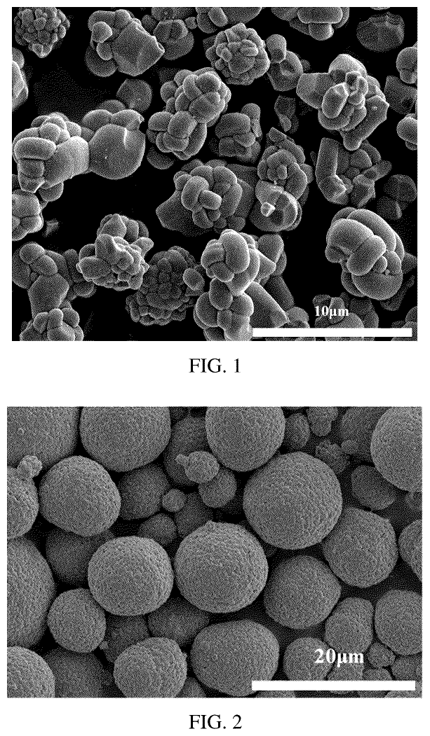

According to an implementation of the present disclosure, the particles having a polymeric single crystal morphology in the positive electrode material are formed by nesting several primary particles. The nesting in the present disclosure is not a core-shell structure, and a core-shell structure has an obvious core structure and a shell structure. The particles having a polymeric single crystal morphology in the present disclosure are formed by nested aggregation of several primary particles, that is, in the formed particles having a polymeric single crystal morphology, one primary particle and a plurality of primary particles are fused and connected in a nested manner through an internal force to form a surrounding structure, for example, as shown in FIG. 1.

According to an implementation of the present disclosure, the several refers to one or two or more.

According to an implementation of the present disclosure, the particle having a polymeric single crystal morphology is formed by nesting 2-500 (for example, 5-100) primary particles.

According to an implementation of the present disclosure, a surface of the particle having a polymeric single crystal morphology is relatively smooth.

According to an implementation of the present disclosure, a structure of the polymeric single crystal morphology of the particle is different from a single crystal structure in the conventional technology, and is also different from a secondary sphere structure. The secondary sphere structure generally exists in a ternary material, and a secondary sphere particle known in the field of the ternary material is a regular sphere-like particle. The secondary sphere particle may also be referred to as a polycrystalline material. A primary particle of the secondary sphere particle is greatly different from a single crystal, a quasi-single crystal, and a polymeric single crystal in the present disclosure, and growth manners thereof are also different.

According to an implementation of the present disclosure, a median particle size d₅₀ of the primary particle ranges from 0.1 μm to 3 μm, and is, for example, 0.1 μm, 0.2 μm, 0.3 μm, 0.4 μm, 0.5 μm, 0.6 μm, 0.7 μm, 0.8 μm, 0.9 μm, 1 μm, 1.1 μm, 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, 2.7 μm, 2.8 μm, 2.9 μm, or 3 μm.

According to an implementation of the present disclosure, a median particle size D₅₀ of the positive electrode material ranges from 0.2 μm to 20 μm, and is, for example, 0.2 μm, 0.3 μm, μm, 0.5 μm, 0.6 μm, 0.7 μm, 0.8 μm, 0.9 μm, 1 μm, 1.1 μm, 1.2 μm, 1.3 μm, 1.4 μm, 1.5 μm, 1.6 μm, 1.7 μm, 1.8 μm, 1.9 μm, 2 μm, 2.1 μm, 2.2 μm, 2.3 μm, 2.4 μm, 2.5 μm, 2.6 μm, 2.7 μm, 2.8 μm, 2.9 μm, 3 μm, 4 μm, 5 μm, 6 μm, 7 μm, 8 μm, 9 μm, 10 μm, 11 μm, 12 μm, 13 μm, 14 μm, μm, 16 μm, 17 μm, 18 μm, 19 μm, or 20 μm.

According to an implementation of the present disclosure, the primary particle is a ternary material or lithium cobaltate. The ternary material may include at least one of a ternary material on which doping and/or encapsulation processing is performed and a ternary material on which doping and/or encapsulation processing is not performed. The lithium cobaltate may include at least one of lithium cobaltate on which doping and/or encapsulation processing is performed and lithium cobaltate on which doping and/or encapsulation processing is not performed.

The high-nickel ternary positive electrode material has attracted attention from new energy industry due to high specific capacity and low raw material cost. However, in the conventional technology, a ternary positive electrode material undergoes a structure change and interface side reaction at high voltage and high temperature, which poses a great challenge to practical application. Furthermore, with an increase of a nickel content in the ternary positive electrode material, thermal stability and safety of the ternary positive electrode material gradually become worse. The inventors of the present disclosure find that thermal decomposition temperature of a positive electrode material is often a key factor affecting thermal runaway of a battery. When the high-nickel ternary positive electrode material includes a particle having a polymeric single crystal morphology, a thermal decomposition temperature of the high-nickel ternary positive electrode material may be increased, so that the positive electrode material has relatively low temperature rise, relatively high thermal stability and high thermal cycle stability.

In an implementation, a chemical formula of the ternary material is LiₐNi_{1-x-y-p}CoₓM¹_{y}M²ₚO₂, where 0.95≤a<1.08, 0.5≤1−x−y−p<1.0, 0<x≤0.3, 0<y≤0.2, and 0<p≤0.005; and M₁ is Mn or Al, and M₂ is one or more of Mg, Sr, Ba, Y, W, Nb, or Mo. Preferably, 0.0005≤p≤0.005.

In an implementation, a chemical formula of the lithium cobaltate is LiₐCo_{1-b}M_{b}O₂, where M is one or more of Al, W, Mg, Ti, Zr, Y, Ce, and Mo, 0.95≤a≤1.07, and 0<b≤0.1.

According to an implementation of the present disclosure, the positive electrode material further includes a coating layer, and the coating layer covers a surface of the particles having a polymeric single crystal morphology.

According to an implementation of the present disclosure, a mass proportion of the coating layer ranges from 500 ppm to 10000 ppm, and is, for example, 500 ppm, 600 ppm, 700 ppm, 800 ppm, 900 ppm, 1000 ppm, 1500 ppm, 1800 ppm, 2000 ppm, 2500 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm, 9500 ppm, or 10000 ppm; that is, a mass of the coating layer accounts for 0.05 wt % wt % of a total mass of the positive electrode material, and is, for example, 0.05 wt %, 0.06 wt %, wt %, 0.08 wt %, 0.09 wt %, 0.1 wt %, 0.15 wt %, 0.2 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, 0.75 wt %, 0.8 wt %, 0.85 wt %, wt %, 0.95 wt %, or 1 wt %.

According to an implementation of the present disclosure, the mass proportion of the coating layer ranges from 500 ppm to 5000 ppm, and is, for example, 500 ppm, 600 ppm, 700 ppm, 800 ppm, 900 ppm, 1000 ppm, 1500 ppm, 1800 ppm, 2000 ppm, 2500 ppm, 3000 ppm, 3500 ppm, 4000 ppm, 4500 ppm, 5000 ppm, 5500 ppm, 6000 ppm, 6500 ppm, 7000 ppm, 7500 ppm, 8000 ppm, 9500 ppm, or 10000 ppm; that is, the mass of the coating layer accounts for 0.05 wt %-0.5 wt % of the total mass of the positive electrode material, and is, for example, 0.05 wt %, 0.06 wt %, wt %, 0.08 wt %, 0.09 wt %, 0.1 wt %, 0.15 wt %, 0.2 wt %, 0.25 wt %, 0.3 wt %, 0.35 wt %, 0.4 wt %, 0.45 wt %, 0.5 wt %, 0.55 wt %, 0.6 wt %, 0.65 wt %, 0.7 wt %, 0.75 wt %, 0.8 wt %, 0.85 wt %, wt %, 0.95 wt %, or 1 wt %.

According to an implementation of the present disclosure, a material forming the coating layer is a metal compound and/or a non-metal compound.

According to an implementation of the present disclosure, the metal compound is selected from at least one of aluminum oxide, tungsten oxide, molybdenum oxide, zirconium oxide, or titanium oxide.

According to an implementation of the present disclosure, the non-metallic compound is selected from boron oxide.

According to an implementation of the present disclosure, the coating layer includes a first coating layer and a second coating layer. The first coating layer covers a surface of the particles having a polymeric single crystal morphology, the second coating layer covers an outer surface of the first coating layer, the first coating layer is a metal compound, and the second coating layer is a metal compound and/or a non-metal compound.

According to an implementation of the present disclosure, in a differential scanning calorimetry (DSC) spectrum of the positive electrode material at a voltage ranging from 4.1 V to 4.4 V, a start exothermic temperature of a main exothermic peak is 278° C. or more, and an integral area of the main exothermic peak is 98 J/g or less.

Preparation of a Positive Electrode

The present disclosure further provides a method for preparing the foregoing positive electrode material, where the method includes the following steps.

Step S11: Uniformly mixing a ternary precursor with D₅₀ less than 7 μm, a lithium source, and a first doping modifier to obtain a precursor mixture.

Step S12: Performing first calcination on the precursor mixture. Through this step, a polymeric single crystal ternary positive electrode material can be obtained.

According to an implementation of the present disclosure, the method further includes the following step.

Step S13: Adding a first coating agent into the material obtained in Step S12, and then performing mixing and first heat treatment. Through this step, a single-layer coated polymeric single crystal ternary positive electrode material can be obtained.

According to an implementation of the present disclosure, the method further includes the following step.

Step S14: Adding a second coating agent to the material obtained in Step S13, and then performing mixing, followed by second heat treatment, third pulverization, and sixth sieving. Through this step, a double-layer coated polymeric single crystal ternary positive electrode material can be obtained.

According to an implementation of the present disclosure, in Step S11, the ternary precursor is Ni_{1-x-y}CoₓM¹_{y}(OH)₂, where 0.5≤1−x−y<1.0, 0<x≤0.3, 0<y≤0.2, and M¹ is Mn or Al.

According to an implementation of the present disclosure, in Step S11, the lithium source is selected from one or more of lithium hydroxide, lithium nitrate, lithium sulfate, lithium chloride, lithium carbonate, lithium phosphate, lithium fluoride, lithium acetate, lithium oxalate, or lithium hydrogen phosphate.

According to an implementation of the present disclosure, in Step S11, the first doping modifier includes one or more of the following doping elements: Mg, Sr, Ba, Y, W, Nb, or Mo, and an added amount of the first doping modifier based on the doping element ranges from 0 ppm to 5000 ppm (0 ppm is excluded). The first doping modifier may include at least one of an oxide and a hydroxide of the foregoing doping elements.

According to an implementation of the present disclosure, in Step S11, a molar ratio of the lithium source to the ternary precursor is (1.01-1.15):1.

According to an implementation of the present disclosure, in Step S11, the mixing is, for example, dry ball milling, a ball milling medium is a zirconia ball or a steel ball, a speed ranges from 200 r/min to 800 r/min, and a duration ranges from 3 hours to 6 hours.

According to an implementation of the present disclosure, Step S12 further includes: performing first sieving before the first calcination.

According to an implementation of the present disclosure, in Step S12, the first calcination is performed in an air atmosphere or an oxygen atmosphere, preferably in an oxygen atmosphere.

According to an implementation of the present disclosure, in Step S12, the first calcination is performed by increasing a temperature to 400° C.-600° C. at 2° C./min-15° C./min and keeping the temperature for 1 hours-6 hours, then increasing the temperature to 700° C.-800° C. at 2° C./min-15° C./min and keeping the temperature for 2 hours-12 hours, finally increasing the temperature to 800° C.-920° C. at 2° C./min-15° C./min and keeping the temperature for 2 hours-16 hours, followed by naturally cooling.

According to an implementation of the present disclosure, in Step S12, first pulverization and second sieving are performed on the material obtained after the first calcination, to obtain the polymeric single crystal ternary positive electrode material.

According to an implementation of the present disclosure, in Step S13, the first coating agent is a metal compound. The metal compound is at least one of a nanometer oxide, a nanometer hydroxide, or a nanometer salt of a metal element, and the metal element is selected from at least one of Al, Ti, Zr, Mo, or W. A nanometer oxide or nanometer hydroxide of Al, Ti or W is preferred. A mass of the first coating agent accounts for 0.05 wt %-0.5 wt % of a mass of the polymeric single crystal ternary positive electrode material.

According to an implementation of the present disclosure, in Step S13, the mixing is high-speed mixing (for example, performed by using a high-speed mixer).

According to an implementation of the present disclosure, Step S13 further includes: performing third sieving before the first heat treatment.

According to an implementation of the present disclosure, in Step S13, the first heat treatment is performed at a constant temperature in an oxygen-containing environment.

According to an implementation of the present disclosure, in Step S13, the first heat treatment at a constant temperature is performed by increasing a temperature to 200° C.-900° C. at 2° C./min-15° C./min and keeping the temperature for 3 hours-16 hours.

According to an implementation of the present disclosure, in Step S13, second pulverization and fourth sieving are performed on the material obtained after the first heat treatment.

According to an implementation of the present disclosure, in Step S14, the second coating agent is at least one of a metal compound and/or a non-metal compound. The metal compound is at least one of a nanometer oxide, a nanometer hydroxide, or a nanometer salt of a metal element, and the metal element is selected from at least one of Al, Ti, Zr, Mo, or W. A nanometer oxide or nanometer hydroxide of Al, Ti or W is preferred. The non-metal compound is selected from boron oxide. A mass of the second coating agent accounts for 0.05 wt %-0.5 wt % of the mass of the polymeric single crystal ternary positive electrode material.

According to an implementation of the present disclosure, Step S14 further includes: performing fifth sieving before the second heat treatment.

According to an implementation of the present disclosure, in Step S14, the mixing is high- speed mixing (for example, performed by using a high-speed mixer).

According to an implementation of the present disclosure, in Step S14, the second heat treatment is performed at a constant temperature in an oxygen-containing environment.

According to an implementation of the present disclosure, in Step S14, the second heat treatment at a constant temperature is performed by increasing a temperature to 200° C.-900° C. at 2° C./min-15° C./min and keeping the temperature for 2 hours-16 hours.

In the conventional technology, a secondary sphere structure generally exists in a ternary material and needs to be synthesized and prepared by using a ternary precursor with D₅₀>7 μm. However, in the preparation method of the present disclosure, a precursor of a ternary material with D₅₀<7 μm (D₅₀ is, for example, 1 μm, 2 μm, 3 μm, 4 μm, 5 μm, 6 μm, 6.5 μm, or a range formed by the foregoing any two point values) is used to prepare the particle having a polymeric single crystal morphology. Growth of a primary particle of the particle having a polymeric single crystal morphology tends to grow in a direction of single crystal, thereby avoiding completely forming a dispersion structure of single crystal.

The present disclosure further provides a method for preparing the foregoing positive electrode material, and the method includes the following step:

Step S21: mixing a cobalt source, a lithium source, and a second dopant modifier, and performing first sintering.

In Step S21, the first sintering is performed by increasing a temperature to 730° C.-750° C. at a temperature rise rate of 2° C./min-8° C./min (for example, 5° C./min) in an air atmosphere and keeping the temperature for 0.5 hours-2 hours (for example, 1 hour), then increasing the temperature to 980° C.-1000° C. at 2° C./min, and keeping the temperature for 8 hours-10 hours.

In accordance with an implementation of the present disclosure, Step S21 further includes: performing seventh sieving before the first sintering.

According to an implementation of the present disclosure, Step S21 further includes: performing fourth pulverization after the first sintering.

According to an implementation of the present disclosure, Step S21 further includes: performing eighth sieving after the fourth pulverization.

According to an implementation of the present disclosure, in Step S21, the step of adding the seventh sieving can make mixed bulk materials more uniform after sieving, which can be more advantageous for growth of polymeric single crystal obtained after the first sintering.

According to an implementation of the present disclosure, the method further includes the following step:

Step S22: mixing a material obtained in Step S21 with the first coating agent to perform second sintering.

According to an implementation of the present disclosure, Step S22 further includes: performing ninth sieving before the second sintering. According to an implementation of the present disclosure, Step S22 further includes: performing fifth pulverization after the second sintering.

According to an implementation of the present disclosure, Step S22 further includes: performing tenth sieving after the fifth pulverization.

According to an implementation of the present disclosure, the method further includes the following step:

Step S23: mixing the material obtained in Step S22 with the second coating agent and perform third sintering.

According to an implementation of the present disclosure, Step S23 further includes: performing eleventh sieving before the third sintering.

According to an implementation of the present disclosure, Step S23 further includes: performing sixth pulverization after the third sintering.

According to an implementation of the present disclosure, Step S23 further includes: performing twelfth sieving after the sixth pulverization.

According to an implementation of the present disclosure, in Step S21, the cobalt source is one or more of cobaltosic oxide, cobalt oxide, cobalt hydroxide, cobalt carbonate, or cobalt acetate, preferably cobaltosic oxide. D₅₀ of the cobalt source ranges from 5 μm to 20 μm, preferably from 8 μm to 12 μm.

According to an implementation of the present disclosure, the lithium source in Step S21 is one or more of lithium carbonate, lithium hydroxide, lithium chloride, lithium oxide, or lithium nitrate, preferably lithium carbonate and/or lithium hydroxide.

In Step S21, a molar ratio of the lithium source based on Li to the cobalt source based on Co is (1.02-1.07):1, preferably (1.04-1.06):1.

The second doping modifier in Step S21 is at least one of a nanometer oxide, a nanometer hydroxide, or a nanometer salt of the following doped metal, and the doped metal includes at least one of Al, W, Mg, Ti, Zr, Y, Ce, or Mo; and Al, W, Mo, Mg or Zr is preferred. An added amount of the second dopant modifier based on the doping element ranges from 0 ppm to 100000 ppm.

According to an implementation of the present disclosure, a definition of the first coating agent in Step S22 is the same as that in the foregoing description. A mass of the first coating agent accounts for 0.05 wt %-0.5 wt % of a mass of a polymeric single crystal lithium cobaltate positive electrode material.

According to an implementation of the present disclosure, a definition of the second coating agent in Step S23 is the same as that in the foregoing description. A mass of the second coating agent accounts for 0.05 wt %-0.5 wt % of the mass of the polymeric single crystal lithium cobaltate positive electrode material.

Positive Electrode Plate

The present disclosure further provides a positive electrode plate, and the positive electrode plate includes the foregoing positive electrode material.

According to an implementation of the present disclosure, the positive electrode plate includes a positive electrode current collector and a positive electrode active material layer disposed on at least one surface of the positive electrode current collector, and the positive electrode active material layer includes the foregoing positive electrode material.

According to an implementation of the present disclosure, when the positive electrode plate is charged from 10% SOC to 80% SOC at a rate of 0.1 C, in a differential scanning calorimetry (DSC) spectrum of the positive electrode plate, a start exothermic temperature of a main exothermic peak is 220° C. or more, and an integral area of the main exothermic peak is 98 J/g or less.

Battery and Preparation Thereof

The present disclosure further provides a battery, and the battery includes the foregoing positive electrode material or the foregoing positive electrode plate.

According to an implementation of the present disclosure, in this specification, “80% SOC” means that a state of charge (State of Charge, SOC) of a battery is 80% when a ratio of a corresponding capacity at a specific voltage to which the battery is charged at a specified C -rate to a corresponding capacity at a cut-off voltage reaches 80%. When the battery is charged, there is a “full charge state”, that is, a 100% SOC, and a “charging cut-off voltage” is correspondingly set to ensure safe use of the battery. In other words, a secondary battery formed by a positive electrode including the foregoing positive electrode material is charged to the charging cut-off voltage within a range in which reversible charge/discharge is performed. The “fully charge state” or the “charging cut-off voltage” varies due to different positive electrode materials or a difference in safety requirements. SOC=Charging capacity Q/Full-charge capacity Q*100%.

According to an implementation of the present disclosure, in this specification, in combination with a correspondence between an “SOC” and a charging voltage and a charging capacity, a positive electrode material in a range from 10% SOC to 80% SOC is obtained for research. Specifically, a series of batteries that use the positive electrode material are separately charged to 2.8 V-4.3 V at a rate of 0.1 C, where a preferred charging voltage interval is 0.1 V, that is, 2.8 V, 2.9 V, 3.0 V, . . . , 4.2 V, and 4.3 V, and charging capacities Q corresponding to different voltages are recorded, where 4.3 V is the charging cut-off voltage, and a corresponding capacity is the full-charge capacity Q. Ratios of the charging capacity to the full-charge capacity Q, namely, charging capacity Q/full-charge capacity Q, in different voltages are calculated, so as to obtain 10% SOC-80% SOC.

According to the present disclosure, it should be specifically noted that, when the battery is charged to 10% SOC-80% SOC, a positive electrode plate of the battery is disassembled to perform a DSC test, for example, 50% SOC, 60% SOC, 70% SOC, or 80% SOC.

The present disclosure provides a preparation method for the foregoing battery, including the following steps:

Step S31: weighing 100 g of the polymeric single crystal positive electrode material, a conductive agent Super P, and a binder polyvinylidene fluoride (PVDF) according to a weight ratio of 96:2:2 in sequence, mixing them in 40 g N-methylpyrrolidone (NMP), stirring the mixture in vacuum to obtain a uniform slurry, then applying the slurry on an aluminum foil current collector evenly, performing roll baking at 100° C. in a 10 m oven (with a rolling belt at 2 m/min) and vacuum baking at 85° C. for 20 hours, and then performing cold pressing and slitting to obtain a positive electrode plate;

Step S32: weighing 100 g of artificial graphite: conductive agent Super P: carboxymethyl cellulose (CMC): styrene-butadiene rubber (SBR) according to a weight ratio of 95:2:1.5:1.5 in sequence, mixing them in 40 g deionized water, stirring the mixture in vacuum to obtain a uniform slurry, then applying the slurry on a copper foil current collector evenly, performing roll baking at 100° C. in a 10 m oven (with a rolling belt at 2 m/min) and vacuum baking at 85° C. for 20 hours, and then performing cold pressing and slitting to obtain a negative electrode plate;

Step S33: stacking the positive electrode plate, the negative electrode plate, and a separator to form a lithium-ion cell, packing the lithium-ion cell in a pouch battery package, and injecting an electrolyte solution with ethyl carbonate (EC) containing 1 mol/L lithium hexafluorophosphate (LiPF6): methyl ethyl carbonate (EMC): diethyl carbonate (DEC)=1:1:1 (volume ratio), and with 2 wt % vinylene carbonate (VC) and 3 wt % 1,3-propane sultone (PS); and

Step S34: after steps such as hot pressing, formation, cold pressing, aging, secondary sealing, and sorting, obtaining a lithium-ion battery that uses polymeric single crystal ternary positive electrode as a positive active material.

The present disclosure will be further described in detail below with reference to specific embodiments. It should be understood that the following examples are only for illustrating and explaining the present disclosure, and should not be construed as limiting the protection scope of the present disclosure. All technologies implemented based on the foregoing contents of the present disclosure are within the scope of protection of the present disclosure.

Experimental methods used in the following examples are conventional methods, unless otherwise specified. Reagents, materials, and the like used in the following examples are all commercially available, unless otherwise specified.

Testing of an initial DC internal resistance in the following Examples is as follows: 1. standing for 10 minutes; 2. discharging to a cut-off voltage of 2.75 V at 0.2 C; and 3. standing for 10 minutes; setting aside at a corresponding test temperature for a period of time until a stable state is reached (the duration should not be less than 2 hours), and performing discharge for a specific period of time with a specific pulse current, so as to calculate DCIR.

### Example Group A

This example group is used to describe a preparation method and a positive electrode material and a battery that are prepared by using the preparation method.

### Example A1

(1) Ni_{0.65}Co_{0.15}Mn_{0.2}(OH)₂ with D₅₀ ranging from 3 μm to 7 μm (excluding 7 μm) and Li₂CO₃ were mixed in a high-speed mixing manner at 400 r/min according to a molar ratio Li/(Ni+Co+Mn) of 1.05:1, and then a specific amount of nanometer Mo₂O₃ and nanometer WO₃ were added and further mixed in a high-speed mixing manner at 400 r/min. A molar ratio of added Mo₂O₃ to Ni_{0.65}Co_{0.15}Mn_{0.2}(OH)₂ is 0.2%, and a molar ratio of added WO₃ to Ni_{0.65}Co_{0.15}Mn_{0.2}(OH)₂ is 0.3%. The mixture was put into a sagger and sintered for the first time in a box furnace, and oxygen was introduced as sintering atmosphere. The synthesis was performed mainly in three stages at constant temperature, and a heating rate between the stages was set to 2° C./min: a low-temperature stage was kept at 400° C. for 1 hour; a medium-temperature stage was kept at 700° C. for 2 hours; and a high-temperature stage was kept at 900° C. for 12 hours. Then, after the box furnace was cooled naturally, the material was taken out and pulverized by jet, and then sieved with a 300-mesh sieve to obtain a polymeric single crystal ternary material.

In the polymeric single crystal ternary material, a quantity n of primary particles ranges from 5 to 100, and a median particle size D₅₀ of the positive electrode material is 4.08 μm (an average value is taken after three times of test is performed by using a laser particle size analyzer); and a median particle size d 50 of the primary particles ranges from 0.2 1.tm to 1.5 The following relational expression shown in Formula 1 is met:

D₅₀³=K×n×d₅₀³ Formula 1,

where K ranges from 0.3 to 2.

The obtained polymeric single crystal ternary material was evenly mixed with nanometer Al₂O₃, where Al₂O₃ and the polymeric single crystal ternary material were designed at a mass ratio of 1000 ppm. Sintering was performed for the second time by increasing a temperature to 600° C. at 2° C./min in an oxygen atmosphere and keeping the temperature for 10 hours. After cooling, a single-layer coated polymeric single crystal ternary material was obtained. The obtained single-layer coated polymeric single crystal ternary material was evenly mixed with nanometer WO₃, where WO₃ and the single-layer coated polymeric single crystal ternary material were designed according to a mass ratio of 2000 ppm. Sintering was performed for the third time by increasing a temperature to 500° C. at 2° C./min in an oxygen atmosphere and keeping the temperature for 10 hours. After cooling, a double-layer coated polymeric single crystal ternary material was obtained. A scanning electron microscope image is shown in FIG. 1.

(2) 100 g of the polymeric single crystal positive electrode material, a conductive agent Super P, and a binder PVDF were weighed according to a weight ratio of 96:2:2 in sequence and mixed in 40 g NMP. The mixture was stirred in vacuum to obtain a uniform slurry. Then the slurry was applied on an aluminum foil current collector evenly, followed by roll baking at 100° C. in a m oven (with a rolling belt at 2 m/min) and vacuum baking at 85° C. for 20 hours, cold pressing, and slitting, so as to obtain a positive electrode plate containing the double-layer coated polymeric single crystal ternary positive electrode material.

(3) 100 g of artificial graphite: conductive agent Super P: CMC: SBR were weighed according to a weight ratio of 95:2:1.5:1.5 in sequence, and mixed in 40 g deionized water. The mixture was stirred in vacuum to obtain a uniform slurry. Then the slurry was applied on a copper foil current collector evenly, followed by roll baking at 100° C. in a 10 m oven (with a rolling belt at 2 m/min) and vacuum baking at 85° C. for 20 hours, cold pressing, and slitting, so as to obtain a negative electrode plate.

(4) The positive electrode plate, the negative electrode plate, and a separator were stacked to form a lithium-ion cell. The lithium-ion cell was packed in a pouch battery package, and an electrolyte solution with ethyl carbonate (EC) containing 1 mol/L lithium hexafluorophosphate (LiPF 6): methyl ethyl carbonate (EMC): diethyl carbonate (DEC) =1:1:1 (volume ratio), and with 2 wt % vinylene carbonate (VC) and 3 wt % 1,3-propane sultone (PS) was injected.

(5) After steps such as hot pressing, formation, cold pressing, aging, secondary sealing, and sorting, a lithium-ion battery that uses a double-layer coated polymeric single crystal ternary positive electrode material as a positive active material was obtained.

### Comparative Example A1

Ni_{0.65}Co_{0.15}Mn_{0.2}(OH)₂ with D₅₀ ranging from 10 μm to 20 μm and Li₂CO₃ were mixed in a high-speed mixing manner at 300 r/min according to a molar ratio Li/(Ni+Co+Mn) of 1.05:1.0; and the mixture was put into a sagger and sintered for the first time in a box furnace, and oxygen was introduced as sintering atmosphere. The synthesis was performed mainly in three stages at constant temperature, and a heating rate between the stages was set to 2° C./min: a low-temperature stage was kept at 400° C. for 1 hour; a medium-temperature stage was kept at 700° C. for 2 hours; and a high-temperature stage was kept at 780° C. for 12 hours. Then, after the box furnace was cooled naturally, the material was taken out and pulverized mechanically, and then sieved with a 300-mesh sieve to obtain a secondary sphere ternary material. A scanning electron microscope image is shown in FIG. 2.

The obtained secondary sphere ternary material was evenly mixed with nanometer Al₂O₃, where Al₂O₃ and Li_{1.05}Ni_{0.65}Co_{0.15}Mn_{0.2}O₂ were designed according to a mass ratio of 1000 ppm. Sintering was performed for the second time by increasing a temperature to 600° C. at 2° C./min in an oxygen atmosphere and keeping the temperature for 10 hours. After cooling, a single-layer coated secondary sphere ternary material was obtained.

In the secondary sphere ternary material, a quantity n of primary particles is greater than 500, and a median particle size D₅₀ of the positive electrode material is 10 μm (an average value is taken after three times of test is performed by using a laser particle size analyzer); and a median particle size d₅₀ of the primary particles ranges from 0.1 μm to 0.5 μm.

Thus, the following relational expression shown in Formula 1 is not met: D₅₀³=K×n×d₅₀³ Formula 1.

### Comparative Example A2

Ni_{0.65}Co_{0.15}Mn_{0.2}(OH)₂ with D₅₀ less than 10 μm and Li₂CO₃ were mixed in a high-speed mixing manner at 400 r/min according to a molar ratio Li/(Ni+Co+Mn) of 1.05:1.0. The mixture was put into a sagger and sintered for the first time in a box furnace, and oxygen was introduced as sintering atmosphere. The sintering was performed at 930° C. for 24 hours; and after the box furnace was cooled naturally, the material was taken out and pulverized, and then sieved with a 300-mesh sieve. Then, after a muffle furnace was cooled naturally, the material was taken out and pulverized by jet, and then sieved with a 300-mesh sieve to obtain a single crystal ternary material. A scanning electron microscope image is shown in FIG. 4.

The obtained single crystal ternary material was evenly mixed with nanometer Al₂O₃, where Al₂O₃ and Li_{1.05}Ni_{0.65}Co_{0.15}Mn_{0.2}O₂ were designed according to a molar ratio of 1000 ppm. Sintering was performed for the second time at 600° C. for 10 hours in an oxygen atmosphere. After cooling, a single-layer coated single crystal ternary material was obtained.

In the single crystal ternary material, a quantity n of primary particles is 1, and a median particle size D₅₀ of the positive electrode material is 3.56 μm (an average value is taken after three times of test is performed by using a laser particle size analyzer); and a median particle size d₅₀ of the primary particles is 3.56 μm.

### Example A2

Other operations are the same as those in Example A1, and a difference only lies in that: Step (1) is specifically as follows:

(1) N_{0.65}Co_{0.15}Mn_{0.2}(OH)₂ with D₅₀ ranging from 3 μm to 7 μm (excluding 7 μm) and Li₂CO₃ were mixed in a high-speed mixing manner at 400 r/min according to a molar ratio Li/(Ni+Co+Mn) of 1.05:1, and then a specific amount of nanometer Mo₂O₃ and nanometer WO₃ were added and further mixed in a high-speed mixing manner at 400 r/min. A molar ratio of added Mo₂O₃ to Ni_{0.65}Co_{0.15}Mn_{0.2}(OH)₂ is 0.25%, and a molar ratio of added WO₃ to Ni_{0.65}Co_{0.15}Mn_{0.2}(OH)₂ is 0.25%. The mixture was put into a sagger and sintered for the first time in a box furnace, and oxygen was introduced as sintering atmosphere. The synthesis was performed mainly in three stages at constant temperature, and a heating rate between the stages was set to 2° C./min: a low-temperature stage was kept at 400° C. for 1 hour; a medium-temperature stage was kept at 700° C. for 2 hours; and a high-temperature stage was kept at 910° C. for 12 hours. Then, after the box furnace was cooled naturally, the material was taken out and pulverized by jet, and then sieved with a 300-mesh sieve to obtain a polymeric single crystal ternary material.

In the polymeric single crystal ternary material, a quantity n of primary particles ranges from 5 to 200, and a median particle size D₅₀ of the positive electrode material is 3.92 μm (an average value is taken after three times of test is performed by using a laser particle size analyzer); and a median particle size d₅₀ of the primary particles ranges from 0.15 μm to 1.3 μm. The following relational expression shown in Formula 1 is met:

D₅₀³=K×n×d₅₀³ Formula 1,

where K ranges from 0.25 to 2.

The obtained polymeric single crystal ternary material was evenly mixed with nanometer Al₂O₃, where Al₂O₃ and the polymeric single crystal ternary material were designed at a mass ratio of 1000 ppm. Sintering was performed for the second time by increasing a temperature to 600° C. at 2° C./min in an oxygen atmosphere and keeping the temperature for 10 hours. After cooling, a single-layer coated polymeric single crystal ternary material was obtained. The obtained single-layer coated polymeric single crystal ternary material was evenly mixed with nanometer WO₃, where WO₃ and the single-layer coated polymeric single crystal ternary material were designed according to a mass ratio of 2500 ppm. Sintering was performed for the third time by increasing a temperature to 500° C. at 2° C./min in an oxygen atmosphere and keeping the temperature for 10 hours. After cooling, a double-layer coated polymeric single crystal ternary material was obtained.

### Example group A3

This example group is used to describe an impact of a coating layer.

For this example group, reference is made to Example A1. A difference lies in that: different operations are separately performed in Step (1) after the polymeric single crystal ternary material is obtained, specifically,

in Example A3a, coating was not performed;

in Example A3b, only first-layer coating was performed, that is, the obtained polymeric single crystal ternary material was evenly mixed with nanometer Al₂O₃, where Al₂O₃ and the polymeric single crystal ternary material were designed at a mass ratio of 1000 ppm; sintering was performed for the second time by increasing a temperature to 600° C. at 2° C./min in an oxygen atmosphere and keeping the temperature for 10 hours; and after cooling, a single-layer coated polymeric single crystal ternary material was obtained; and

in Example A3c, double-layer coating was performed, but the second layer was boron oxide, a nonmetallic oxide, specifically: The obtained polymeric single crystal ternary material was evenly mixed with nanometer Al₂O₃, where Al₂O₃ and the polymeric single crystal ternary material were designed at a mass ratio of 1000 ppm. Sintering was performed for the second time by increasing a temperature to 600° C. at 2° C./min in an oxygen atmosphere and keeping the temperature for 10 hours; after cooling, a single-layer coated polymeric single crystal ternary material was obtained; the obtained single-layer coated polymeric single crystal ternary material was evenly mixed with nanometer B₂O₃, where B₂O₃ and the single-layer coated polymeric single crystal ternary material were designed according to a mass ratio of 800 ppm. Sintering was performed for the third time by increasing a temperature to 500° C. at 2° C./min in an oxygen atmosphere and keeping the temperature for 10 hours; and after cooling, a double-layer coated polymeric single crystal ternary material was obtained.

### Example group A4

This example group is used to describe an impact of different doping elements and doping amounts.

For this example group, reference is made to Example A1. A difference lies in that: the doping element and/or the doping amount are changed in Step (1), specifically:

in Example A4a, a specific amount of nanometer TiO₂, nanometer Al₂O₃, and nanometer MgO were added, where a molar ratio of added TiO₂ to Ni_{0.65}Co_{0.15}Mn_{0.2}(OH)₂ is 0.12%, a molar ratio of added Al₂O₃ to Ni_{0.65}Co_{0.15}Mn_{0.2}(OH)₂ is 0.2%, and a molar ratio of added MgO to Ni_{0.65}Co_{0.15}Mn_{0.2}(OH)₂ is 0.05%;

in Example A4b, a specific amount of nanometer Mo₂O₃, nanometer WO₃, and nanometer TiO₂ were added, where a molar ratio of added Mo₂O₃ to Ni_{0.65}Co_{0.15}Mn_{0.2}(OH)₂ is 0.2%, a molar ratio of added WO₃ to Ni_{0.65}Co_{0.15}Mn_{0.2}(OH)₂ is 0.3%, and a molar ratio of added TiO₂ to Ni_{0.65}Co_{0.15}Mn_{0.2}(OH)₂ is 0.12%;

in Example A4c, a specific amount of nanometer TiO₂ and nanometer Al₂O₃ were added, where a molar ratio of added TiO₂ to Ni_{0.65}Co_{0.15}Mn_{0.2}(OH)₂ is 0.12%, and a molar ratio of added Al₂O₃ to Ni_{0.65}Co_{0.15}Mn_{0.2}(OH)₂ is 0.2%; and in Example A4d, a specific amount of nanometer Mo₂O₃ and nanometer WO₃ were added, where a molar ratio of added Mo₂O₃ to Ni_{0.65}Co_{0.15}Mn_{0.2}(OH)₂ is 0.02%, and a molar ratio of added WO₃ to Ni_{0.65}Co_{0.15}Mn_{0.2}(OH)₂ is 0.03%.

### Example group A5

This example group is used to describe an impact of a mass proportion of different coating layers.

For this example group, reference is made to Example A1. A difference lies in that: an amount of added coating layer in Step (1) is changed, specifically:

in Example A5a, Al₂O₃ and the polymeric single crystal ternary material were designed according to a mass ratio of 2000 ppm, and WO₃ and the single-layer coated polymeric single crystal ternary material were designed according to a mass ratio of 2000 ppm;

in Example A5b, Al₂O₃ and the polymeric single crystal ternary material were designed according to a mass ratio of 3000 ppm, and WO₃ and the single-layer coated polymeric single crystal ternary material were designed according to a mass ratio of 2000 ppm; and in Example A5c, Al₂O₃ and the polymeric single crystal ternary material were designed according to a mass ratio of 1000 ppm, and WO₃ and the single-layer coated polymeric single crystal ternary material were designed according to a mass ratio of 3000 ppm.

### Test Example

(a) Performance Test

(1) The batteries in Examples and Comparative Examples were each allowed to stand in a room temperature environment of 25° C. for 24 hours, charged to 4.3 V at a current rate of 0.1 C of a sorting capacity, and allowed to stand for 10 minutes and then discharged at a current rate of of a design capacity until the voltage became 3.0 V. The discharge capacity this time was used as a reference, and the batteries each were charged to 4.3 V at 0.1 C, 0.2 C, 0.5 C, 1.0 C, 2.0 C, and 10 C, separately after being left to stand for 10 minutes, and then discharged at a charging current rate until the discharge voltage became 3.0 V. An interval between each charging and discharging was 10 minutes, charging and discharging at each C-rate was cycled five times, and the discharge C-rate was calculated. The test results are shown in Table 1.

(2) The batteries in Examples and Comparative Examples were each allowed to stand in a constant temperature environment of 45° C. for 24 hours, charged to 4.3 V with the current rate of 1C, and charged at a constant voltage of 4.3 V, with a cut-off current being 0.05 C. Then the batteries were allowed to stand for 10 minutes and then discharged at a same current until the voltage became 3.0 V, forming a charge-discharge cycle. After the batteries were allowed to stand for 10 minutes, a next cycle was performed, and the whole cycle was performed in an environment of 45° C. The test results are shown in Table 1.

Description of Test Results:

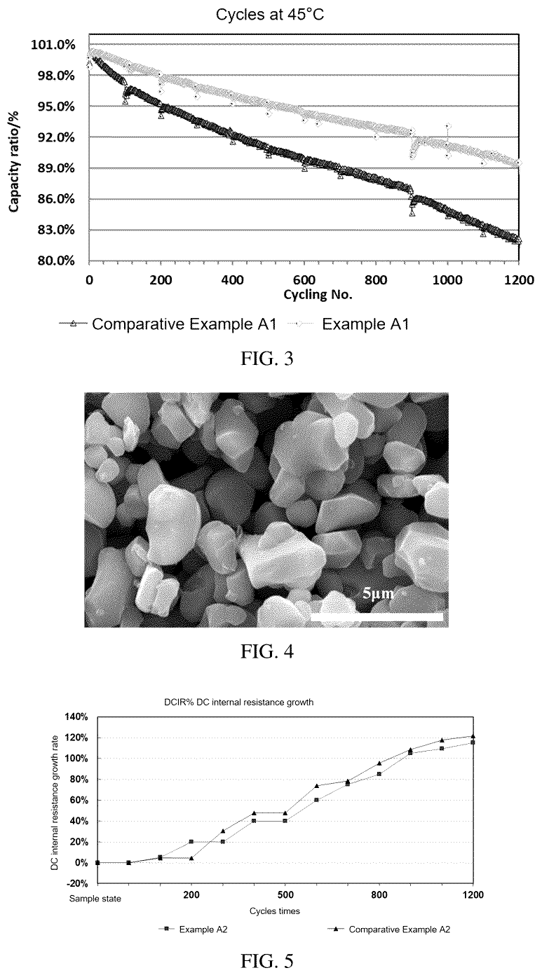

According to data in Table 1, the battery in Example A1 may reach 180.1 mAh/g when being discharged from the upper limit voltage 4.3 V to 3.0 V, with 89.42% capacity retention rate after 1200 cycles at 45° C. under this voltage. In Example A1 and Comparative Examples A1 and A2, the particle size of the precursor was adjusted, and a substance containing Mo and W was added during the synthesis to regulate a growth mode of the primary particles and calcination temperature, so that a polymeric single crystal morphology, a single crystal morphology, and a secondary sphere morphology are separately formed. It may be clearly learned from FIG. 3 and Table 1 that, in a high voltage up to 4.3 V and high C-rate cycle, the cycling performance of polymeric single crystal material is higher than that of a secondary sphere material, and the C-rate performance is much higher than that of a single crystal material, thereby solving a problem that a ternary material cannot consider both good C-rate performance and cycle stability performance.

TABLE 1
Performance test results of lithium-ion batteries in Examples and Comparative
Examples A1 and A2

| | | | | | | | | | Capacity |
|---|---|---|---|---|---|---|---|---|---|
| | | | | | | | | | retention |
| | | | | | | | | | rate after |
| | 0.1 C | | | | | | | | 1200 |
| | discharge | | | | | | | | cycles at |
| | capacity | Discharge capacity retention rate at different C-rates | | | | | | | constant |
| | (mAh/g) | 0.1 C | 0.2 C | 0.5 C | 1.0 C | 2.0 C | 5.0 C | 10.0 C | 45° C. |
| Example A1 | 180.1 | 100.00% | 98.95% | 97.59% | 96.95% | 96.54% | 96.50% | 96.72% | 89.42% |
| Example A2 | 179.8 | 100.00% | 98.50% | 97.20% | 96.60% | 96.17% | 96.11% | 96.31% | 89.31% |
| Example | 182.5 | 100.00% | 99.21% | 98.11% | 97.31% | 97.08% | 97.02% | 97.22% | 86.42% |
| A3a | | | | | | | | | |
| Example | 180.5 | 100.00% | 98.90% | 97.89% | 97.09% | 96.78% | 96.60% | 96.80% | 88.73% |
| A3b | | | | | | | | | |
| Example | 180.3 | 100.00% | 99.09% | 97.79% | 97.39% | 96.76% | 96.70% | 96.90% | 89.02% |
| A3c | | | | | | | | | |
| Example | 179.2 | 100.00% | 99.36% | 98.53% | 97.70% | 97.27% | 97.21% | 97.41% | 87.95% |
| A4a | | | | | | | | | |
| Example | 179.9 | 100.00% | 99.01% | 97.91% | 96.81% | 96.48% | 96.62% | 96.82% | 88.78% |
| A4b | | | | | | | | | |
| Example | 179.3 | 100.00% | 99.35% | 98.19% | 97.59% | 97.16% | 97.10% | 97.30% | 86.43% |
| A4c | | | | | | | | | |
| Example | 182.1 | 100.00% | 98.38% | 96.98% | 96.18% | 95.75% | 95.69% | 95.89% | 87.20% |
| A4d | | | | | | | | | |
| Example | 179.9 | 100.00% | 98.64% | 97.34% | 96.74% | 96.31% | 96.25% | 96.45% | 89.50% |
| A5a | | | | | | | | | |
| Example | 179.6 | 100.00% | 98.45% | 97.15% | 96.55% | 96.12% | 96.06% | 96.26% | 89.45% |
| A5b | | | | | | | | | |
| Example | 179.6 | 100.00% | 98.49% | 97.19% | 96.59% | 96.16% | 96.10% | 96.30% | 89.50% |
| A5c | | | | | | | | | |
| Comparative | 184.2 | 100.00% | 99.04% | 97.63% | 97.04% | 96.77% | 96.99% | 97.68% | 82.74% |
| Example A1 | | | | | | | | | |
| Comparative | 178.2 | 100.00% | 98.92% | 97.60% | 96.04% | 96.20% | 95.19% | 94.66% | 89.79% |
| Example A2 | | | | | | | | | |

(b) Performance Test:

(1) After the batteries in the foregoing examples and comparative examples were each allowed to stand in a room temperature environment of 25° C. for 24 hours, the following tests were performed: measuring initial direct current resistances R1 and R2; and discharging the batteries at a rate ranging from 0.5 C to 10 C, with a charge/discharge voltage ranging from 2.75 V to 4.3 V, and measuring temperatures of the batteries that are discharged at the rate. The temperature rise results are shown in Table 2.

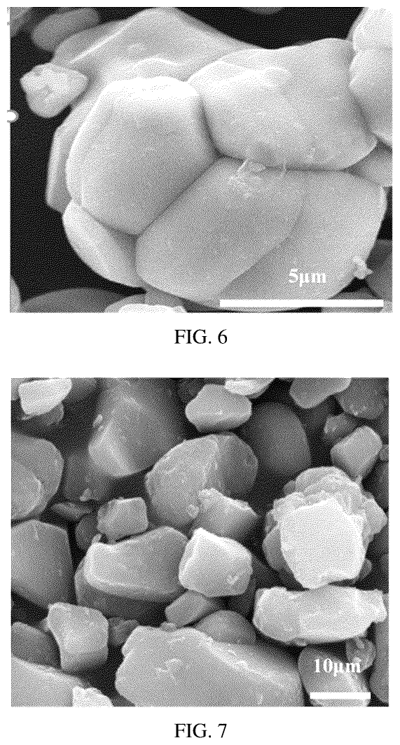

(2) After the batteries in the foregoing Example 2 and Comparative Example A2 were each allowed to stand in a room temperature environment of 25° C. for 24 hours, the following tests were performed: measuring initial direct current resistances R1 and R2; and performing 1200 cycles of charge and discharge at a rate of 1 C, with the voltage ranging from 2.75 V to 4.3 V, and detecting changes of the initial direct current resistances during the 1200 cycles, as shown in FIG. 5.

TABLE 2
Temperature rise on the cell surface of batteries in Examples and Comparative
Examples at a same discharge C-rate

| | | 0.5 C/° C. | 1.0 C/° C. | 2.0 C/° C. | 3.0 C/° C. | 5.0 C/° C. | 10.0 C/° C. |
|---|---|---|---|---|---|---|---|
| Example A1 | 1# | 0.80 | 1.40 | 3.20 | 4.80 | 9.50 | 18.60 |
| | 2# | 0.80 | 1.30 | 3.30 | 4.70 | 8.70 | 19.10 |
| Example A2 | 1# | 0.80 | 1.10 | 2.90 | 4.40 | 8.50 | 17.20 |
| | 2# | 0.80 | 1.50 | 3.00 | 4.20 | 8.20 | 17.00 |
| Comparative | 1# | 0.75 | 1.2 | 2.70 | 3.90 | 6.30 | 15.1 |
| Example A1 | 2# | 0.74 | 1.0 | 2.60 | 3.70 | 6.50 | 14.8 |
| Comparative | 1# | 1.00 | 2.10 | 3.70 | 5.80 | 9.90 | 19.80 |
| Example A2 | 2# | 1.00 | 2.20 | 3.80 | 6.20 | 10.20 | 20.10 |

Description of Test Results:

For a battery assembled with polymeric single crystal ternary material (Example A2), an initial DC internal resistance R1=5 mΩ; and for a battery assembled with a single crystal ternary material (Comparative Example A2), an initial DC internal resistance R2=23 mΩ. After 1200 cycles, a DC internal resistance growth rate of the polymeric single crystal is equivalent to that of the single crystal.

According to the data in Table 2, with increase of the charge/discharge C-rate, the surface temperature of the batteries tends to increase, and an increase of the temperature based on the polymeric single crystal is lower than that based on the single crystal, which also proves that the particle morphology of the polymeric single crystal is superior to that of the single crystal in terms of temperature rise control. According to the data in Table 2, with continuous increase of the charge C-rate, the battery temperature based on the single crystal material increases obviously, and the increase of battery temperature based on the polymeric single crystal is lower than that based on the single crystal material. This indicates that a polymeric single crystal ternary material has an advantage over a single crystal in temperature control during charge and discharge at a large C- rate.

(c) Performance Test:

Four button batteries were taken from each of the foregoing examples and comparative examples, where one battery was charged from 2.8 V to a cut-off voltage of 4.3 V at a C-rate of 0.1 C to test the full-charge capacity; and remaining batteries were charged to different cut-off voltages to test the capacity, that is, the remaining batteries were respectively kept in a state of 4.1 V, 4.2 V, and 4.4 V, to dismantle the batteries, and test DSC of the positive electrode plate. The initial exothermic temperatures are shown in Table 3 and the peak temperatures are shown in Table 4.

TABLE 3
Data comparison of DSC initial exothermic temperatures of positive
electrode materials in examples and comparative examples

| DSC initial temperature at | | | | |
|---|---|---|---|---|
| different voltages (° C.) | 4.1 V | 4.2 V | 4.3 V | 4.4 V |
| Example A1 | 285.8 | 281.2 | 276.8 | 269.2 |
| Example A2 | 285.2 | 280.4 | 276.1 | 268.7 |
| Comparative Example A1 | 255.7 | 249.6 | 245.3 | 238.6 |
| Comparative Example A2 | 264.3 | 260.3 | 257.4 | 249.7 |

TABLE 4
Data comparison of DSC main exothermic peak temperatures of
positive electrode materials in examples and comparative examples

| DSC peak temperature at | | | | |
|---|---|---|---|---|
| different voltages (° C.) | 4.1 V | 4.2 V | 4.3 V | 4.4 V |
| Example Al | 292.0 | 287.3 | 282.8 | 280.1 |
| Example A2 | 289.0 | 284.9 | 280.6 | 278.4 |
| Comparative Example A1 | 268.8 | 264.2 | 257.3 | 251.2 |
| Comparative Example A2 | 276.3 | 273.2 | 259.3 | 264.1 |

Description of test results: According to the data shown in Table 3 and Table 4, both the initial exothermic temperature and the main exothermic peak temperature for the polymeric single crystal are higher than that for the secondary sphere particles, indicating that the structural stability of the polymeric single crystal is better than that of the secondary sphere morphology.

### Example Group B

This example group is used to describe another preparation method and a positive electrode material and a battery that are prepared by using the preparation method.

### Example B1

Cobaltosic oxide with D₅₀ ranging from 8 μm to 10 μm nanometer magnesium hydroxide, and tungsten oxide powder were mixed uniformly at a high speed in a high-speed ball mill, where added amounts of magnesium hydroxide and tungsten oxide respectively account for 0.6 wt % and 1.4 wt % of the mass of cobaltosic oxide. Then, lithium carbonate was added to the mixture to mix in a high-speed manner, where lithium carbonate was added at a Li/Co molar ratio of 1.05:1, and after being mixed uniformly, the mixture was sieved with a 300-mesh sieve, to finally obtain a mixed powder.

The mixed powder was heated up to 750° C. at a rate of 5° C./min in an air atmosphere and kept at this temperature for 1 hour, and then the temperature was increased to 980° C. at a rate of 2° C./min and was kept for 8 hours. The obtained sintered material was naturally cooled, and then pulverized by jet. In a pulverizing process, a median particle size D₅₀ of the material is controlled to range from 9 μm to 12 μm, that is, the material is polymeric single crystal lithium cobaltate, and an SEM diagram of the material is shown in FIG. 6.

In the polymeric single crystal lithium cobaltate, a quantity n of primary particles ranges from 3 to 80, and a median particle size D₅₀ of the positive electrode material is 10.67 μm; and a median particle size d₅₀ of the primary particles ranges from 2 μm to 3 μm. The following relational expression shown in Formula 1 is met:

D₅₀³=K×n×d₅₀³ Formula 1,

where K ranges from 0.25 to 2.

The obtained polymeric single crystal lithium cobaltate and nanometer aluminum hydroxide were uniformly mixed to obtain a mixed powder, where aluminum hydroxide accounts for 0.15 wt % of the mass of the polymeric single crystal lithium cobaltate, and the mixed powder was sintered at 960° C. for 10 hours in an air atmosphere. The obtained sintered material was naturally cooled, and then sieved with a 300-mesh sieve to obtain a single-layer coated polymeric single crystal lithium cobaltate positive electrode material.

The obtained single-layer coated polymeric single crystal lithium cobaltate positive electrode material and nanometer zirconium oxide were uniformly mixed to obtain a mixed powder, where the zirconium oxide accounts for 0.18 wt % of the mass of the single-layer coated polymeric single crystal lithium cobaltate, and the mixed powder was sintered at 960° C. for 10 hours in an air atmosphere. The obtained sintered material was naturally cooled, and then sieved with a 300-mesh sieve to obtain a double-layer coated polymeric single crystal lithium cobaltate positive electrode material.

100 g of the double-layer coated polymeric single crystal lithium cobaltate positive electrode material, a conductive agent Super P, and a binder PVDF were weighed according to a weight ratio of 96:2:2 in sequence and mixed in 40 g NMP. The mixture was stirred in vacuum to obtain a uniform slurry. Then the slurry was applied on an aluminum foil current collector evenly, followed by roll baking at 100° C. in a 10 m oven (with a rolling belt at 2 m/min) and vacuum baking at 85° C. for 20 hours, cold pressing, and slitting, so as to obtain a positive electrode plate.

100 g of artificial graphite: conductive agent Super P: CMC: SBR were weighed according to a weight ratio of 95:2:1.5:1.5 in sequence, and mixed in 40 g deionized water. The mixture was stirred in vacuum to obtain a uniform slurry. Then the slurry was applied on a copper foil current collector evenly, followed by roll baking at 100° C. in a 10 m oven (with a rolling belt at 2 m/min) and vacuum baking at 85° C. for 20 hours, cold pressing, and slitting, so as to obtain a negative electrode plate.

The positive electrode plate, the negative electrode plate, and a separator were stacked to form a lithium-ion cell. The lithium-ion cell was packed in a pouch battery package, and an electrolyte solution with ethyl carbonate (EC) containing 1 mol/L lithium hexafluorophosphate (LiPF₆): methyl ethyl carbonate (EMC): diethyl carbonate (DEC)=1:1:1 (volume ratio), and with 2 wt % vinylene carbonate (VC) and 3 wt % 1,3-propane sultone (PS) was injected.

After steps such as hot pressing, formation, cold pressing, aging, secondary sealing, and sorting, a lithium-ion battery was obtained.

### Comparative Example B1

Cobaltosic oxide with D₅₀ greater than 10 μm and lithium carbonate were added to the foregoing mixture and mixed in a high-speed manner, and lithium carbonate was added at a Li/Co molar ratio of 1.05:1, to finally obtain a mixed powder.

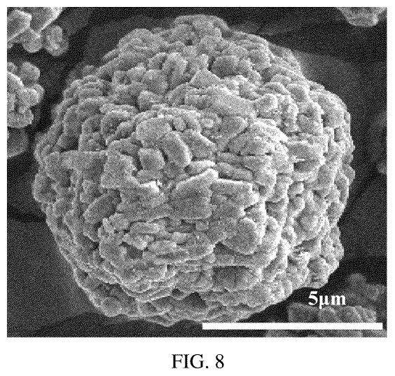

The mixed powder was heated up to 1100° C. in an air atmosphere and kept at this temperature for 24 hours. The obtained sintered material was naturally cooled, and then pulverized by jet, to obtain single crystal lithium cobaltate. An SEM diagram of the material is shown in FIG. 7.

In the single crystal lithium cobaltate, a quantity n of primary particles is 1, and a median particle size D₅₀ of the positive electrode material is 14.34 μm; and a median particle size d₅₀ of the primary particles is 14.34 μm.

The obtained single crystal lithium cobaltate and nanometer aluminum hydroxide were uniformly mixed to obtain a mixed powder, where aluminum hydroxide accounts for 0.3 wt % of the mass of the single crystal lithium cobaltate, and the mixed powder was sintered at 800° C. for 16 hours in an air atmosphere. The obtained sintered material was naturally cooled, and then sieved with a 300-mesh sieve to obtain a single-layer coated single crystal lithium cobaltate positive electrode material.

100 g of the single-layer coated single crystal lithium cobaltate positive electrode material, a conductive agent Super P, and a binder PVDF were weighed according to a weight ratio of 96:2:2 in sequence and mixed in 40 g NMP. The mixture was stirred in vacuum to obtain a uniform slurry. Then the slurry was applied on an aluminum foil current collector evenly, followed by roll baking at 100° C. in a 10 m oven (with a rolling belt at 2 m/min) and vacuum baking at 85° C. for 20 hours, cold pressing, and slitting, so as to obtain a positive electrode plate.

100 g of artificial graphite: conductive agent Super P: CMC: SBR were weighed according to a weight ratio of 95:2:1.5:1.5 in sequence, and mixed in 40 g deionized water. The mixture was stirred in vacuum to obtain a uniform slurry. Then the slurry was applied on a copper foil current collector evenly, followed by roll baking at 100° C. in a 10 m oven (with a rolling belt at 2 m/min) and vacuum baking at 85° C. for 20 hours, cold pressing, and slitting, so as to obtain a negative electrode plate.

The positive electrode plate, the negative electrode plate, and a separator were stacked to form a lithium-ion cell. The lithium-ion cell was packed in a pouch battery package, and an electrolyte solution with ethyl carbonate (EC) containing 1 mol/L lithium hexafluorophosphate (LiPF₆): methyl ethyl carbonate (EMC): diethyl carbonate (DEC)=1:1:1 (volume ratio), and with 2 wt % vinylene carbonate (VC) and 3wt % 1,3-propane sultone (PS) was injected.

After steps such as hot pressing, formation, cold pressing, aging, secondary sealing, and sorting, a lithium-ion battery was obtained.

### Comparative Example B2

Cobaltosic oxide with D₅₀ greater than 10 μm and lithium carbonate were added to the foregoing mixture and mixed in a high-speed manner, and lithium carbonate was added at a Li/Co molar ratio of 1.05:1, to finally obtain a mixed powder.

The mixed powder was heated up to 900° C. in an air atmosphere and kept at this temperature for 24 hours. The mixed powder was naturally cooled and sieved, to obtain a secondary sphere lithium cobaltate. An SEM diagram of the secondary sphere lithium cobaltate is shown in FIG. 8. The secondary sphere lithium cobaltate was pulverized to obtain polymorphic primary sintered lithium cobaltate formed by agglomerating a plurality of primary single crystal particles, where a quantity of single crystal particles is more than or equal to 500.

In the secondary sphere lithium cobaltate, a quantity n of primary particles is greater than 500, and a median particle size D₅₀ of the positive electrode material is 9.54 μm; and a median particle size d₅₀ of the primary particle ranges from 0.5 μm to 21 μm.

Thus, the following relational expression shown in Formula 1 is not met: D₅₀³=K×n×d₅₀³ Formula 1.

The obtained secondary sphere lithium cobaltate and nanometer aluminum hydroxide were uniformly mixed to obtain a mixed powder, where aluminum hydroxide accounts for 0.3 wt % of the mass of the lithium cobaltate, and the mixed powder was sintered at 820° C. for 16 hours in an air atmosphere. The obtained sintered material was naturally cooled, and then sieved with a 300-mesh sieve to obtain a single-layer coated secondary sphere lithium cobaltate positive electrode material.

100 g of the single-layer coated secondary sphere lithium cobaltate positive electrode material, a conductive agent Super P, and a binder PVDF were weighed according to a weight ratio of 96:2:2 in sequence and mixed in 40 g NMP. The mixture was stirred in vacuum to obtain a uniform slurry. Then the slurry was applied on an aluminum foil current collector evenly, followed by roll baking at 100° C. in a 10 m oven (with a rolling belt at 2 m/min) and vacuum baking at 85° C. for 20 hours, cold pressing, and slitting, so as to obtain a positive electrode plate.

100 g of artificial graphite: conductive agent Super P: CMC: SBR were weighed according to a weight ratio of 95 2:1.5:1.5 in sequence, and mixed in 40 g deionized water. The mixture was stirred in vacuum to obtain a uniform slurry. Then the slurry was applied on a copper foil current collector evenly, followed by roll baking at 100° C. in a 10 m oven (with a rolling belt at 2 m/min) and vacuum baking at 85° C. for 20 hours, cold pressing, and slitting, so as to obtain a negative electrode plate.

The positive electrode plate, the negative electrode plate, and a separator were stacked to form a lithium-ion cell. The lithium-ion cell was packed in a pouch battery package, and an electrolyte solution with ethyl carbonate (EC) containing 1 mol/L lithium hexafluorophosphate (LiPF₆): methyl ethyl carbonate (EMC): diethyl carbonate (DEC)=1:1:1 (volume ratio), and with 2 wt % vinylene carbonate (VC) and 3 wt % 1,3-propane sultone (PS) was injected.

After steps such as hot pressing, formation, cold pressing, aging, secondary sealing, and sorting, a lithium-ion battery was obtained.

TABLE 5
Performance test results of batteries in Example B1 and Comparative Examples B1 and B2

| | | | | | | | | | Capacity |
|---|---|---|---|---|---|---|---|---|---|
| | | | | | | | | | retention |
| | | | | | | | | | rate after |
| | 0.1 C | | | | | | | | 800 cycles |
| | discharge | | | | | | | | at room |
| | capacity | Discharge capacity retention rate at different C-rates (%) | | | | | | | temperature |
| Case | (mAh/g) | 0.1 C | 0.2 C | 0.5 C | 1.0 C | 2.0 C | 5.0 C | 10.0 C | 25° C. (%) |
| Example B1 | 189.6 | 100.00% | 98.80% | 96.35% | 94.63% | 92.75% | 91.75% | 91.07% | 92.7 |
| Comparative | 187.9 | 100.00% | 96.44% | 91.99% | 89.84% | 86.48% | 84.34% | 81.53% | 94.2 |
| Example B1 | | | | | | | | | |
| Comparative | 191.2 | 100.00% | 99.75% | 98.32% | 97.13% | 95.58% | 94.66% | 93.49% | 83.1 |
| Example B2 | | | | | | | | | |

The results in Table 5 show that the polymeric single crystal lithium cobaltate has an advantage over the single crystal lithium cobaltate in terms of capacity per gram, and has an advantage over the secondary sphere in terms of cycles at room temperature 25° C.

The implementations of the present disclosure have been illustrated above. However, the present disclosure is not limited to the foregoing implementations. Any modification, equivalent replacement, improvement, or the like, made within the spirit and principles of the present disclosure shall fall within the protection scope of the present disclosure.

What is claimed is:

1. A positive electrode material, comprising several particles having a polymeric single crystal morphology, wherein the particle having a polymeric single crystal morphology is formed by nesting several primary particles; and the positive electrode material meets a relational expression shown in Formula 1 as follows:
D₅₀³=K×n×d₅₀³ Formula 1,
wherein K is a coefficient having a range of 0.2≤K≤2; n is a quantity of primary particles having a range of 2≤n≤500; D₅₀ is a median particle size of a positive electrode material, in a unit of μm; and d₅₀ is a median particle size of a primary particle, in a unit of μm.

2. The positive electrode material according to claim 1, wherein 5≤n≤100.

3. The positive electrode material according to claim 1, wherein a median particle size d₅₀ of the primary particles ranges from 0.1 μm to 3 μm.

4. The positive electrode material according to claim 1, wherein a median particle size D₅₀ of the positive electrode material ranges from 0.2 μm to 20 μm.

5. The positive electrode material according to claim 1, wherein the primary particles are a ternary material or lithium cobaltate; the ternary material comprises at least one of a ternary material on which doping and/or encapsulation processing is performed and a ternary material on which doping and/or encapsulation processing is not performed; and the lithium cobaltate comprises at least one of lithium cobaltate on which doping and/or encapsulation processing is performed and lithium cobaltate on which doping and/or encapsulation processing is not performed.

6. The positive electrode material according to claim 5, wherein a chemical formula of the ternary material is LiₐNi_{1-x-y-p}CoₓM¹_{y}M²ₚO₂, wherein 0.95≤a<1.08, 0.5≤1−x−y−p<1.0, 0 <x≤0.3, 0<y≤0.2, and 0<p≤0.005; and M¹ is Mn or Al, and M² is one or more of Mg, Sr, Ba, Y, W, Nb, or Mo.

7. The positive electrode material according to claim 6, wherein 0.0005≤p≤0.005.

8. The positive electrode material according to claim 6, wherein the particle having a polymeric single crystal morphology is prepared by using a precursor of the ternary material with D₅₀<7 μm.

9. The positive electrode material according to claim 4, wherein a chemical formula of the lithium cobaltate is LiₐCo_{1-b}M_{b}O₂, wherein M is one or more of Al, W, Mg, Ti, Zr, Y, Ce and Mo, 0.95≤a≤1.07, and 0<b≤0.1.

10. The positive electrode material according to claim 1, wherein the positive electrode material further comprises a coating layer, and the coating layer covers a surface of the particles having a polymeric single crystal morphology.

11. The positive electrode material according to claim 10, wherein a mass of the coating layer accounts for 0.05 wt %-1 wt % of a total mass of the positive electrode material.

12. The positive electrode material according to claim 10, wherein the mass of the coating layer accounts for 0.05 wt %-0.5 wt % of the total mass of the positive electrode material.

13. The positive electrode material according to claim 10, wherein a material forming the coating layer is a metal compound and/or a non-metal compound; and/or the metal compound is selected from at least one of aluminum oxide, tungsten oxide, molybdenum oxide, zirconium oxide, or titanium oxide; and/or the non-metal compound is selected from boron oxide.

14. The positive electrode material according to claim 10, wherein the coating layer comprises a first coating layer and a second coating layer, the first coating layer covers a surface of the several particles having a polymeric single crystal morphology, the second coating layer covers an outer surface of the first coating layer, the first coating layer is a metal compound, and the second coating layer is a metal compound and/or a non-metal compound; and/or the metal compound is selected from at least one of aluminum oxide, tungsten oxide, molybdenum oxide, zirconium oxide, or titanium oxide; and/or the non-metal compound is selected from boron oxide. The positive electrode material according to claim 14, wherein a mass of the first coating layer accounts for 0.05 wt %-0.5 wt % of a total mass of the positive electrode material.

16. The positive electrode material according to claim 14, wherein a mass of the second coating layer accounts for 0.05 wt %-0.5 wt % of the total mass of the positive electrode material.

17. The positive electrode material according to claim 1, wherein in a differential scanning calorimetry spectrum of the positive electrode material at a voltage ranging from 4.1 V to 4.4 V, a start exothermic temperature of a main exothermic peak is 278° C. or more, and an integral area of the main exothermic peak is 98 J/g or less.

18. A positive electrode plate, comprising the positive electrode material according to claim 1.

19. The positive electrode plate according to claim 18, wherein when the positive electrode plate is charged from 10% SOC to 80% SOC at a rate of 0.1C, in a differential scanning calorimetry spectrum of the positive electrode plate, a start exothermic temperature of a main exothermic peak is 220° C. or more, and an integral area of the main exothermic peak is 98 J/g or less.

20. A battery, comprising the positive electrode material according to claim 1.
